(19) United States
(12) Patent Application Publication
(10) Pub. No.: US 2026/0204022 A1
(43) Pub. Date: Jul. 16, 2026

(54) GENERATION OF A 3D OBJECT FROM AN IMAGE USING MACHINE LEARNING MODELS

(71) Applicant: Stability AI Ltd, London (GB)

(72) Inventors: Mark Boss, Tübingen (DE); Zixuan Huang, Urbana, IL (US); Aaryaman Vasishta, London (GB); Varun Jampani, Rockland, MA (US)

(73) Assignee: Stability AI Ltd, London (GB)

(21) Appl. No.: 19/445,351

(22) Filed: Jan. 9, 2026

Related U.S. Application Data
(60) Provisional application No. 63/743,820, filed on Jan. 10, 2025.

(51) Int. Cl. G06T 17/20; G06T 15/06

(52) U.S. Cl. CPC G06T 17/20; G06T 15/06

(57) ABSTRACT

Techniques include generating an image embedding based at least in part on an object. The techniques further include generating a point cloud associated with the object based at least in part on the image embedding. The techniques further include generating a triplane embedding representing the object based at least in part on the image embedding and the point cloud. The techniques further include generating, based at least in part on the triplane embedding, at least one of (i) a first three-dimensional mesh associated with the object or (ii) a first texture for the first three-dimensional mesh associated with the object.

### CROSS REFERENCE TO RELATED APPLICATIONS

This application claims the benefit of and priority to U.S. Provisional Application No. 63/743,820, filed Jan. 10, 2025, and titled “Generation of A 3D Object from an Image Using Machine Learning Models,” the content of which is herein incorporated by reference in its entirety for all purposes.

### BACKGROUND

Artificial intelligence models (e.g., generative artificial intelligence models) have gained mainstream attention recently for their capabilities. Despite the impressive progress that has been made in the field of machine learning, existing techniques for training artificial intelligence models and use cases of artificial intelligence models could be further improved.

### BRIEF DESCRIPTION OF THE DRAWINGS

Features, embodiments, and advantages of the present disclosure are better understood when the following Detailed Description is read with reference to the accompanying drawings.

FIG. 1 is a block diagram illustrating an example asset generation system, according to certain embodiments.

FIG. 2 is a block diagram illustrating an example asset generation system, according to certain embodiments.

FIG. 3 is a block diagram illustrating an example point cloud system, according to certain embodiments.

FIG. 4 is a block diagram illustrating an example triplane generation system, according to certain embodiments.

FIG. 5 is a block diagram illustrating an example scene attribute map system, according to certain embodiments.

FIG. 6 is a block diagram illustrating an example mesh generation system, according to certain embodiments.

FIG. 7 is a block diagram illustrating an example differentiable rendering system, according to certain embodiments.

FIG. 8 is a block diagram illustrating an example method of using an asset generation system, according to certain embodiments.

FIG. 9 depicts a block diagram of an exemplary computer apparatus, according to embodiments.

### DETAILED DESCRIPTION

Certain embodiments describe techniques for generating three-dimensional (3D) assets from an input, such as an image, by producing a 3D asset and/or associated artifact (e.g., mesh, mapping, etc.). This capability is valuable across a range of applications and industries, including computer vision, graphics, artificial intelligence (AI), gaming, e-commerce, augmented reality (AR), and virtual reality (VR).

Constructing a high quality 3D asset and/or artifact of an object from an image or other input can present challenges, particularly in inferring the geometry of occluded or backside regions of the object that are not directly observable from the image or other input. These ambiguities can introduce uncertainty and often lead to suboptimal or incomplete reconstructions. To address these challenges and to achieve high fidelity, the 3D asset and/or artifact may include a dense, well-structured network of vertices, edges, and faces that accurately represent the surface geometry of the object in three-dimensional space. The 3D asset and/or artifact may capture fine-grained details and complex surface contours, with each vertex enriched by additional attributes such as surface normals, texture attributes, material properties, etc. Furthermore, reproduction of the object's appearance under varying lighting conditions may use detailed mappings and/or assets, such as color, albedo, normal or orientation maps, roughness, illumination or reflectance data, etc.

Certain embodiments described herein can address these challenges by integrating neural networks that generate and refine intermediate 3D representations (e.g., point clouds and triplane embeddings) from a single input image. These intermediate 3D representations can capture both observed and plausible unobserved regions, allowing the system to produce dense, high quality meshes and detailed texture (or other attribute) maps that can reproduce the object's geometry and appearance, even under atypical or ambiguous visual conditions.

Another challenge with generating a high quality 3D asset and/or artifact from a single image or input is that it can be computationally and resource intensive. The techniques described can involve not only reconstructing the visible surfaces, but also inferring structures for occluded or ambiguous regions, determining intrinsic surface color from lighting and shadow effects, and determining the placement and attributes of mesh elements. An underlying mesh representation of the image and/or input could be implemented as a near continuous volume object, which could mean more than a thousand, one-hundred thousand, or one million mesh elements. Mesh representations (e.g., with around 10,000 to 20,000 vertices paired with a texture resolution on the order of 1024×1024 pixels) can be resource intensive. These requirements may necessitate the coordinated use of neural networks and high-dimensional feature representations (such as triplane embeddings). These operations can demand substantial computational resources, including significant processing power and memory, especially when targeting real-time and/or high-resolution outputs.

The described techniques can also addresses aspects of the described challenges by enabling machine learning models to leverage features and point clouds to reconstruct dense 3D assets and/or artifacts (e.g., meshes, mappings, etc.) from limited or ambiguous input, by guiding subsequent stages of the pipeline with geometric and appearance information encoded in the point cloud and feature embeddings.

The techniques disclosed herein can enable rapidly and automatically generating accurate 3D asset and/or artifact which can result in improvements to computer graphics systems, rendering pipelines, and computing devices. By producing high-fidelity geometry and surface attributes (e.g. colors, normals, albedo, etc.) with low latency and minimal manual intervention, the disclosed techniques can improve the quality of generated graphics, reduce computational overhead in downstream processes, and/or enhance the overall performance and reliability of graphics and simulation workloads. These improvements can translate into improvements in frame rate stability, memory utilization, cache coherency, energy consumption, and/or network bandwidth efficiency across a wide range of devices including mobile, embedded, and cloud-based platforms.

Embodiments can enable, for a given computational budget (e.g., processor cycles, memory bandwidth, rendering resources, etc.) the system can produce a 3D asset and/or an artifact with higher or equivalent perceptual quality, geometric fidelity, and/or material realism compared to conventional approaches. Alternatively, the embodiments described herein can enable the generation of visually equivalent 3D asset and/or artifact with reduced computational overhead, thereby improving the efficiency and functioning of underlying components of the computing environment (e.g., GPUs, CPUs, memory subsystems, network, etc.). By utilizing the techniques described herein, it is possible to quickly generate or update 3D assets, meshes, texture maps, or other artifacts from just a single image or other input, thereby producing the end 3D object much faster. As a result, the disclosed can shorten the time and computational overhead needed to display new or updated 3D content, which is especially valuable in real-time settings like augmented reality (AR), virtual reality (VR), and interactive graphics. This can lead to more stable tracking, quicker system responses, and/or better overall performance for both server and client devices.

### I. System Architectures

Systems described herein may include systems for training and using various models (e.g., a diffusion model, an encoder, etc.) and systems. The various models may be used to provide an asset generation system that can generate output based on input.

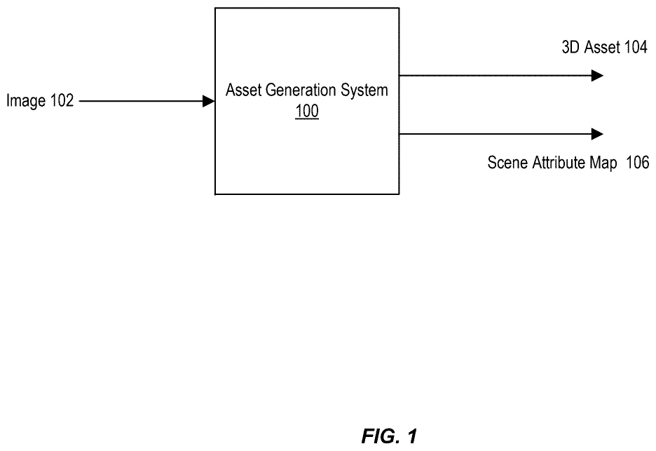

One or more systems and/or models may be included in an inference system. The models may be trained as described herein. FIG. 1 is a block diagram illustrating an example asset generation system 100, according to certain embodiments. The asset generation system 100 may be configured to generate a 3D asset 104 and/or a scene attribute map 106 based on an image 102. The 3D asset 104 may refer to an artifact, such as a 3D mesh, attribute mapping (e.g., texture, albedo, illumination, etc.), or any other digital representation or data structure generated by the asset generation system 100.

The image 102 may be received from a user device, a user interface, system separate from the asset generation system 100, and/or video storage, etc. The image 102 may have been generated by an image generation model (e.g., a text-to-image model). The image 102 may be an object. In some embodiments, the image 102 may include an image of an object. The object may be a physical object or virtual object. The image 102 may include an image captured from a camera view. The camera view may be a physical camera view (e.g., captured by a camera of a mobile device) or virtual camera view (e.g., an image captured by a virtual camera in a virtual space). The camera view may include a position in a coordinate space. The coordinate space may be two dimensional or three dimensional. The camera view may include an orientation in the coordinate space. The orientation may represent angle(s) of the camera placed at a specific position (e.g., pitch, role, etc.).

The asset generation system 100 may use the image 102 to generate the 3D asset 104 The 3D asset 104 may be a 3D mesh. The 3D asset 104 may include a digital representation of one or more surfaces of a 3D object (e.g., the object included in the image 102), defined by a collection of vertices, edges, and/or faces arranged in a geometric structure. The vertices may specify points in a 3D space. The edges may connect pairs of vertices. The faces may include triangular or quadrilateral faces. The faces can form a visible surface of the object.

The 3D asset 104 may be represented in various ways, including polygonal meshes, which use flat surfaces to approximate curved geometry, or more complex formats such as subdivision surfaces or parametric representations that allow for smoother contours. The 3D asset 104, which may be a 3D mesh representation of the object associated with the image 102, can be useful because it provides a flexible and efficient data structure for rendering, manipulating, and/or analyzing 3D objects in digital environments. By using the 3D asset 104, graphics systems can be enabled to apply textures, lighting, and/or shading directly to the 3D object's surface, which can enable realistic visualization of the object within an environment. Additionally, 3D asset 104 can be compact (e.g., occupying less storage than other representations of a 3D object) and computationally efficient (e.g., to modify, to perform processing on, and/or to render, etc.), allowing the 3D asset 104 to be applicable in computer graphics, simulation, animation, gaming, and/or industrial design, etc. The 3D asset 104 may represent an asset that includes textures, but may not in certain embodiments.

The scene attribute map 106, which may be referred to as “map 106,” may be a type of 3D map. A 3D map can define how the 3D asset's 104 surface is “unwrapped” so that a 2D texture can be laid onto the 3D asset 104 without distortion. The map 106 may include a flattened representation of the 3D asset's 104 surface that can inform a rendering system with information regarding how to apply images and/or materials to the 3D asset 104. In addition to or alternatively, the map 106 may be an artifact. An artifact can be any digital representation or data structure generated by the asset generation system 100 that describes the geometry, appearance, and/or physical properties of the object, including but not limited to, a point cloud, a texture map, a normal map, an environment or illumination map, or any intermediate or composite representation used for rendering, analysis, or downstream processing.

The 3D map may be a data structure or coordinate framework that defines how a 3D asset 104 is represented and textured in a digital environment. In computer graphics, a 3D map can provide a mapping between a geometry of the 3D asset 104 (its vertices, edges, and/or surfaces) and additional information such as colors, albedo, textures, and/or surface properties. The mapping can enable a rendering system to accurately project visual details onto the 3D asset 104 so that the 3D asset 104 appears realistic and/or stylized when displayed. For example, the 3D map may contain coordinates that specify how a 2D texture image wraps around the surfaces of a 3D asset 104. The 3D map can prevent a texture from appearing distorted. The 3D map can enable applications and rendering engines to efficiently handle multiple 3D assets and textures, reduce memory usage, and/or control visual fidelity. By using a 3D map, complex scenes with many objects can be rendered smoothly while maintaining precise alignment between geometry and/or surface details, which can be critical in fields such as gaming, simulation, virtual reality, and/or scientific visualization.

After generation, the 3D asset 104 and/or the scene attribute map 106 may be transmitted to one or more downstream systems or devices for further processing, visualization, or deployment. For example, the 3D asset 104 and/or the scene attribute map 106 may be sent over a network to a client application, cloud-based rendering service, or graphics engine for real-time visualization or integration into augmented reality (AR), virtual reality (VR), or gaming environments. In some embodiments, the 3D asset 104 and/or the scene attribute map 106 may be transmitted to a digital asset management system, e-commerce platform, or manufacturing pipeline for storage, cataloging, or fabrication. The transmission of the 3D asset 104 and/or the scene attribute map 106 may utilize standard communication protocols and may be performed in response to user requests, automated workflows, or as part of a continuous processing pipeline.

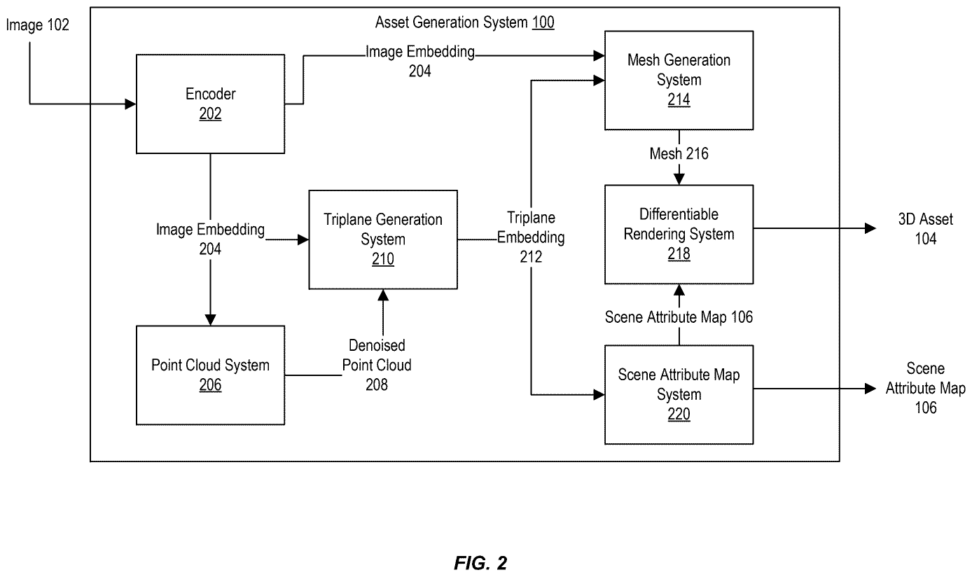

FIG. 2 is a block diagram illustrating an example asset generation system 100 (e.g., asset generation system 100 described above), according to certain embodiments. Asset generation system 100 may comprise an encoder 202, a point cloud system 206, a triplane generation system 210, a mesh generation system 214, a differentiable rendering system 218, and/or a scene attribute map system 220.

The asset generation system 100 may receive an image (e.g., image 102 described above). The image 102 may be received by the encoder 202. The asset generation system 100 may use image 102 to generate a 3D asset 104 (e.g., 3D asset 104 described above) and/or a scene attribute map 106 (e.g., scene attribute map 106 described above).

The encoder 202 receive as input the image 102. The encoder 202 may comprise a neural network, a sequence of algorithm transformations, and/or a computational module configured to receive input data and transform it into one or more feature embeddings, and the like. The encoder 202 can be configured to receive input such as image 102 but, in addition to or alternatively, may be configured to receive input data such as text, signals, numbers, etc. and generate one or more output based on the input. Image 102 received by encoder 202 may be processed by the encoder 202 to generate one or more embeddings (also referred to as feature embeddings or features). These embeddings generated by encoder 202 can represent salient characteristics of the image 102 in a high-dimensional vector space. The encoder 202 is capable of converting complex data, such as images, text, or other modalities, into numerical representations suitable for downstream processing. By representing inputs using numeric embeddings, the encoder 202 can enable faster processing and effective pattern recognition in subsequent operations.

The encoder 202 may generate embeddings by applying a sequence of transformations to extract salient characteristics from the input data. Such transformations may be generated using convolutional layers, attention mechanisms, and/or fully connected (dense) layers, and similar components. The encoder 202 may also incorporate normalization layers within this sequence to ensure consistent feature scaling and standardize the input data. Additionally, activation functions may be used to introduce nonlinearity and allow the encoder 202 to learn the relative importance of different features. In some embodiments, the encoder 202 may further include positional or contextual encodings to preserve information about the spatial, sequential, or contextual relationships among the input elements, enabling the encoder to distinguish features based on their position or order within the input data.

The encoder 202 can generate an embedding based on the input, such as an image embedding 204 derived from image 102. The image embedding 204 may be a high-dimensional feature representation of image 102 and can be structured as a sequence of token embeddings, a feature vector, or a similar data structure. For example, when the input is an image such as image 102, the encoder 202 may generate a sequence of image token embeddings 204, where each image token embedding 204 is a high-dimensional vector corresponding to a localized region or patch of the image. These image token embeddings 204 may be generated by dividing the image 102 into sections (i.e., patches), projecting each section into a feature space, and processing the resulting sequence through one or more neural network layers. This sequence can encode both local and global visual information, enabling the encoder 202 to capture fine-grained details as well as overall context.

For other types of input, such as video, text, or multimodal data, the sequence of token embeddings may be generated by appropriately partitioning the input (for example, into spatio-temporal blocks for video or tokens for text), embedding each partition, and processing the sequence through neural network layers suited to the specific modality.

The image embedding 204 may be received by the point cloud system 206. The point cloud system 206 can generate an intermediate representation for further downstream processing by the asset generation system 100 and/or other systems/processes, as described in greater detail below. Specifically, the point cloud system 206 may generate a denoised point cloud 208 based on the image embedding 204.

The point cloud system 206 can comprise a point diffusion model configured to generate one or more point clouds conditioned on the image embedding 204. A point diffusion model can operate by iteratively refining a set of randomly initialized points in two-dimensional (2D) or three-dimensional (3D) space. The point diffusion model may comprise one or more transformers. Each transformer may comprise one or more normalization layers, one or more multi-head attention head (MHA) layers, and/or one or more multilayer perceptrons.

The process performed by the point cloud system 206 may begin with an initial set of points sampled from a noise distribution, such as Gaussian noise. The resolution of this point set may be defined by n, representing the number of points in the point cloud; in some embodiments, n is set to 512. Each point in the initial set may be initialized (optionally conditioned on the image embedding 204) with channels corresponding to geometric attributes (such as 3D coordinates) and albedo (intrinsic color). Additionally or alternatively, these channels may represent other attributes, including but not limited to, surface orientation (e.g., normals), metallicity, roughness, or color.

The point diffusion model may comprise a forward process that adds noise to the initially sampled point cloud and a backward process in which a neural network, such as a transformer-based denoiser, is trained to remove the noise. In some embodiments, the denoiser predicts a noise residual for each channel, enabling the resulting denoised point cloud to encode not only the object's geometric structure, but also attribute information at each point, such as color, surface orientation (e.g., normals), or material properties.

This approach can be more computationally efficient and offer advantages because determining certain object attributes (e.g., especially albedo) can be difficult because different combinations of lighting and intrinsic color can produce the same observed image. For example, a dark object under bright lighting may appear similar to a bright object under dim lighting. By using the point diffusion model to directly sample plausible combinations of geometry and albedo, and to encode these attributes in the denoised point cloud, the system can reduce ambiguity for downstream rendering processes. Since the albedo may be inferred and encoded at the point cloud stage, later stages are less likely to suffer from ambiguity or entanglement between lighting and intrinsic color.

In the forward process, during training, at each timestep t (where t∈[0, T]), the diffusion model may add noise by combining Gaussian noise ϵ~N(0, I) with point cloud p₀ by computing:

$${p}_{t} = \sqrt{{\overline{α}}_{t}} {p}_{0} + \sqrt{1 - {\overline{α}}_{t}} ε ,$$

where α̅ₜ denotes the noise schedule

The forward process may further utilize a sigmoid noise schedule, optionally combined with input scaling and a renormalization trick, to improve stability and sample quality during diffusion.

In the backward process and during training, the denoiser ϵ_{θ} (pₜ, t; c) is trained to recover the noise added to pₜ from the forward process under supervision of the loss function Lₛᵢₘₚₗₑ(θ):

$${L}_{s i m p l e} ( θ ) = {E}_{t , {p}_{0} , ϵ} {‖ ϵ - {ϵ}_{θ} ( {p}_{t} , t ; c ) ‖}_{2}^{2} ,$$

where c denotes the image condition tokens (e.g., image token embedding 304A described below)

At each denoising step, the denoiser can predict a noise residual for each point, estimating how each point should be adjusted to better match the distribution of real object surfaces. In some embodiments, the denoiser can predict a noise residual corresponding to an attribute of the object such as the albedo. These predictions may be made using a neural network, such as that of a transformer model, which can receive as input both the current noisy point cloud and conditioning information, such as the image embedding 204. The predicted residuals are then used to update the points, progressively moving them closer to the structure and appearance of a plausible 3D object.

This denoising process (e.g., during inference) can be repeated over a series of timesteps, gradually transforming pure noise into an organized, semantically meaningful denoised point cloud. This process is computationally efficient given the low resolution of the point cloud, which reduces computational overhead. The point diffusion model can be conditioned on high-level feature embeddings, such as those derived from the image 102 and represented as image embedding 204, so the generated point cloud accurately reflects both the observed (visible) and plausible unobserved (occluded) portions of the object associated with image 102. Examples of suitable point diffusion models include, but are not limited to, Denoising Diffusion Probabilistic Models (DDPM), Point-E, DPM-Point, Set Diffusion Models, and ShapeNet Diffusion.

The denoised point cloud 208 based on (e.g., based at least in part on) the image embedding 204 generated by the point cloud system may be transmitted to triplane generation system 210. In some embodiments, the denoised point cloud 208 may be transmitted to other systems distinct from the asset generation system 100 for further processing, as will be described in greater detail below.

The triplane generation system 210 may receive the image embedding 204 and/or the denoised point cloud 208. The triplane generation system 210 may generate a triplane embedding 212 based on the image embedding 204 and/or the denoised point cloud 208.

The triplane generation system 210 may include a machine learning model comprising a neural network based on a transformer architecture, which in turn may include a sequence of transformer encoder layers configured to perform attention-based operations on input data. The machine learning model may incorporate feed-forward neural network (FNN) components, which may be artificial neural networks where information flows in a single direction (from the input layer, through one or more hidden layers, to the output layer) without loops or feedback. Such feed-forward models can be used for pattern recognition tasks, including image classification, and may be leveraged within the triplane generation system 210 to accelerate production of the 3D asset.

The triplane generation system 210 may employ a large transformer-based network to generate a triplane embedding 212, which can serve as a high-dimensional volumetric representation of the object depicted in the image 102. The triplane embedding 212 may encode the object's geometry and appearance in a vector space. In some embodiments, the triplane embedding 212 is generated as three orthogonal two-dimensional feature planes. The dimensionality of the triplane embedding 212 may vary by implementation, and in certain embodiments may be 64×64, greater than 64×64, 384×384, or similar.

The neural network within the triplane generation system 210 may process input comprising a combination of multiple data streams, such as the image embedding 204 and/or the denoised point cloud 208. These input data streams may be projected to a common feature dimension (e.g., used to generate embeddings with common dimensionalities) and concatenated to form a unified sequence of dimension-aligned token embeddings. Through multi-head self-attention and cross-attention mechanisms, the transformer network can fuse information from these streams to generate the triplane embedding 212, which then provides a comprehensive 3D representation of the object for downstream rendering, mesh extraction, or texture mapping.

The mesh generation system 214 may receive as input the image embedding 204 generated from the encoder 202 and/or the triplane embedding 212 generated from the triplane generation system 210. The mesh generation system 214 can generate a mesh 216 based on the image embedding 204 and/or triplane embedding 212. The mesh generation system 214 may comprise a machine learning model comprised of one or more shallow neural networks, such as Multi-Layer Perceptrons (MLPs). These shallow neural networks can include an input layer, a single hidden layer, and an output layer, providing a simple but computationally efficient architecture that can reduce inference time and resource consumption while retaining sufficient modeling capacity for the decoding task.

The mesh generation system 214 may sample a set of locations within a defined region of interest. For each sampled location, the mesh generation system 214 may query the triplane embedding 212 to obtain a feature vector that encodes local geometric and appearance information. The appearance information may include, but is not limited to, albedo (intrinsic color) and orientation (e.g., surface normals). Additionally or alternatively, the mesh generation system 214 may query the image embedding 204 to obtain feature vectors that encode material properties such as metallicity and roughness. The shallow neural networks may then decode these feature vectors to predict physical attributes at each location, including density values, surface normal offsets, and albedo.

The predicted density values can be used to construct an explicit surface representing the object's boundary using differentiable Marching Tetrahedra (DMTet) or marching cubes to generate a mesh 216. The mesh 216 can include vertices, edges, and faces arranged in a geometric structure. Additional post-processing, such as normal refinement or Laplacian smoothing, may be performed to improve surface quality and ensure geometric fidelity. The resulting mesh 216 can serve as a high quality representation of the object associated with the image 102, suitable for rendering, further attribute mapping (such as texture generation), or downstream analysis in a wide variety of 3D applications. In some embodiments, mesh 216 can be transmitted to another system distinct from asset generation system 100 for further downstream operations.

The scene attribute map system 220 may receive as input the triplane embedding 212 generated from the triplane generation system 210. The scene attribute map system 220 can generate a scene attribute map 106 (e.g., scene attribute map 106 described above). The scene attribute map 106 can encode global and/or local properties of the object's surrounding environment.

Upon receiving the triplane embedding 212, the scene attribute map system 220 can process triplane embedding 212 by aggregating features across the triplane embedding 212 or by projecting the triplane embedding 212 into a lower-dimensional latent vector that captures relevant scene attributes. This may be accomplished by using a dedicated neural network module to distill the triplane features into a compact attribute embedding. The attribute embedding may represent properties such as scene illumination, environment lighting, or other contextual information.

The scene attribute map system 220 may decode the attribute embedding using a scene attribute decoder, such as a pretrained or learned neural decoder network, into the scene attribute map 106. For example, the scene attribute map system 220 may generate the scene attribute map 106 as a high-dynamic-range (HDR) environment map, a lighting distribution, or other scene descriptors that can be used for downstream rendering, relighting, or material editing tasks.

The scene attribute map 106 thus provides additional information about the environment or context in which the object exists, enabling more realistic rendering, lighting adjustment, or transfer to new scenes. By leveraging the triplane embedding 212 as input, the scene attribute map system 220 can ensure that the generated scene attribute map 106 is consistent with the inferred geometry and appearance of the object, as well as with the visual cues present in the original image 102.

The differentiable rendering system 218 may receive as input the mesh 216 generated from the mesh generation system 214 and the scene attribute map 106 generated from the scene attribute map system 220. In some embodiments, the differentiable rendering system 218 may receive as input any other asset or feature representation generated by the asset generation system 100. The differentiable rendering system 218 may generate a 3D asset 104 (e.g., 3D asset 104 as described above) based on the mesh 216 and scene attribute map 106.

The differentiable rendering system 218 can combine the 3D asset 104, which may represent geometric and albedo information, with the scene attribute map 106, which may represent global or local illumination, environment lighting, or other contextual effects. By integrating these inputs, the differentiable rendering system 218 is capable of simulating how light interacts with the object's surface under various environmental conditions, producing realistic 3D renderings or images of the 3D asset 104.

The differentiable rendering system 218 can implement the rendering process as a differentiable operation, which may entail rasterization, shading, and lighting computations. This can be helpful to enable gradients to be computed and backpropagated through the differentiable rendering system 218. This can also be particularly beneficial during training: it can enables the comparison of synthesized renderings with ground-truth images and the optimization of upstream modules (e.g., the mesh and attribute generators) by minimizing losses defined in image space (such as pixel-wise, perceptual, or silhouette losses).

The differentiable rendering system 218 may include a physically based rendering (PBR) module, such as a differentiable shader that supports advanced material models (e.g., Disney BRDF), and may leverage the scene attribute map 106 to provide environment maps or lighting information for simulating realistic illumination. The output of the differentiable rendering system 218 can include rendered 2D images, shading maps, or other asset representations that depict the reconstructed 3D asset 104 under the inferred scene conditions.

In certain embodiments, the differentiable rendering system 218 may be trained, either in a supervised or unsupervised manner, using the resulting 3D asset 104. During training, the differentiable rendering system 218 can render the 3D asset 104 under a variety of lighting environments and camera viewpoints, based on the scene attribute map 106 and/or other attributes derived from the scene attribute map 106. Additionally or alternatively, the differentiable rendering system 218 may receive other feature attributes for use during training. The 3D asset 104 may be rendered such that the outgoing radiance (e.g., amount of light reflected or emitted from a surface point in a specified direction) from the 3D asset's 104 surface is determined by the differentiable rendering system 218. These rendered outputs can then be compared to corresponding ground-truth images, values, or data using one or more loss functions, such as pixel-wise reconstruction loss, perceptual similarity metrics (e.g., LPIPS), or silhouette consistency. In some embodiments, the outgoing radiance of the 3D asset 104 may be compared to the outgoing radiance of the ground-truth images, values, or data. Because the rendering process is differentiable, the resulting gradients can be back-propagated through the differentiable rendering system 218 to update the parameters of upstream modules, such as the mesh generation system 214 and the scene attribute map system 220.

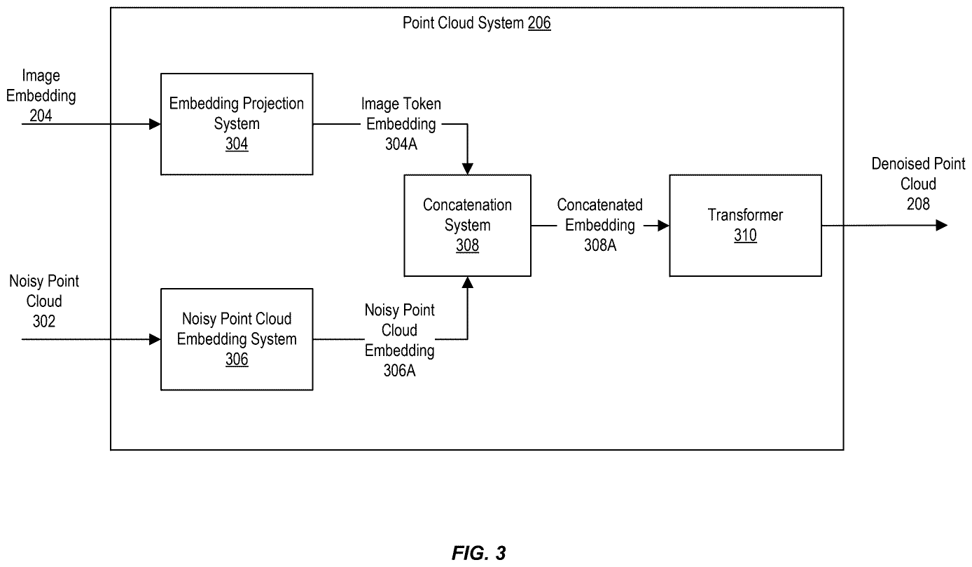

FIG. 3 is a block diagram illustrating an example point cloud system 206 (e.g., point cloud system 206 described above), according to certain embodiments. The point cloud system 206 may generate denoised point cloud 208 (e.g., denoised point cloud 208 described above) based on image embedding 204 (e.g., image embedding 204 described above) and/or noisy point cloud 302. The point cloud system 206 may comprise an embedding projection system 304, a noisy point cloud embedding system 306, a concatenation system 308, and a transformer 310.

The embedding projection system 304 can be configured to receive image embedding 204. The image embedding 204 may comprise one or more high-dimensional token embeddings. The embedding projection system 304 can project each high-dimensional token embedding of the image embedding 204 to a common feature dimension, thereby generating the image token embedding 304A. The image token embedding 304A may comprise a sequence of multiple image token embeddings, each corresponding to a respective high-dimensional token embedding from the image embedding 204 after projection into the common dimension. This is to ensure the resulting image token embedding 304A is dimensionally compatible to be combined with other embeddings, such as the noisy point cloud embedding 306A. The embedding projection system 304 may further include normalization and positional encoding operations to preserve spatial context and ensure feature stability.

The noisy point cloud projection system 306 can be configured to receive noisy point cloud 302. The noisy point cloud 302 may comprise an initial set of randomly distributed points in 3D space, each optionally associated with one or more attribute channels, as described above.

The noisy point cloud 302 may comprise a set of points in 3D space and each point may be associated with one or more attribute channels (e.g. geometry, albedo, and/or color, etc.). The noisy point cloud projection system 306 can project, optionally after tokenization, the per-point features of the noisy point cloud 302 to a common feature dimension, producing the noisy point cloud embedding 306A. The noisy point cloud embedding 306A may comprise a sequence of multiple token embeddings, with each token embedding corresponding to a respective point in the noisy point cloud 302 after projection into the common feature dimension. This is to ensure that the resulting noisy point cloud embedding 306A is dimensionally compatible for combination with other embeddings, such as the image token embedding 304A.

The concatenation system 308 may generate a concatenated embedding 308A based on (e.g., based at least in part on) the image token embedding 304A and the noisy point cloud embedding 306A. The concatenation system 308 can combine the image token embedding 304A and the noisy point cloud embedding 306A along the sequence (token) dimension to produce the concatenated embedding 308A. This can allow the transformer 310, or other neural processing modules, to jointly attend over both image-derived and point cloud-derived information. In some embodiments, the concatenation system 308 may also append type or modality encodings to each token embedding, indicating whether a given token originated from the image or the point cloud stream, thereby facilitating more effective multi-stream fusion.

The transformer 310 can generate a denoised point cloud 208 based on (e.g., based at least in part on) the concatenated embedding 308A. The transformer 310 may comprise a sequence of transformer encoder layers and each encoder layer may each include multi-head self-attention, feed-forward sublayers, normalization, and residual connections.

The transformer 310 can apply attention-based operations that allow each token of the concatenated embedding 308A (whether originating from the image or point cloud) to access and fuse contextual information from all other tokens. This allows the transformer 310 jointly reason about spatial, geometric, and appearance relationships within the concatenated embedding 308A. By applying multi-head self-attention across the concatenated embedding 308A, the transformer 310 may enable each token (whether derived from an the image token embedding 304A or a point in the noisy point cloud embedding 306A) to dynamically integrate information from the entire sequence. This facilitates the modeling of both local and global dependencies, such as spatial proximity, part-whole relationships, and appearance coherence across different regions of the object of image 102. As a result, the transformer 310 can leverage direct visual evidence from the image stream (e.g., edges, texture, color, etc.) while simultaneously incorporating 3D attributes encoded in the denoised point cloud 208 (e.g. albedo). The attention mechanism also enables the transformer 310 to synthesize a unified representation that more accurately reflects the underlying structure and appearance of the target object.

The denoised point cloud 208 may comprise a plurality of points, each represented as an entry in a point cloud tensor that encodes attribute values for each point. The generation of the point cloud may be conditioned at least in part on the image embedding, such that the spatial distribution and attribute values of the points reflect information derived from the input image. Each point included in the denoised point cloud 208 may comprise one or more attributes, which can be organized into a structured data format, such as a tensor of shape [N, M], where N is the number of points and M is the number of attribute channels per point.

In certain embodiments, a point in the denoised point cloud 208 may include at least one of the following attributes: (i) a three-dimensional spatial coordinate, comprising X, Y, and Z components representing the position of the point in three-dimensional space; (ii) a color value, which may encode the intrinsic color or albedo of the point; (iii) a metallic value, representing the extent to which the point's surface exhibits metallic properties; or (iv) an orientation value, such as a surface normal vector associated with the point.

The color value for each point of the denoised point cloud 208 may be further decomposed into one or more channels, including a red (R) channel, a green (G) channel, and a blue (B) channel, collectively specifying the RGB color of the point. In some embodiments, additional channels may be included to encode further material or appearance attributes, such as roughness, transparency, or other scene-specific properties. The organization of the point cloud tensor and its attribute channels can provide a structure for representing the geometric, photometric, and material characteristics of the object being reconstructed.

Although not depicted, a user interface (UI) may be configured to enable interactive visualization and manipulation of the denoised point cloud 208 generated by the point cloud system 206. This UI may present the denoised point cloud 208 within a three-dimensional workspace, where each point is rendered according to its geometric coordinates and, where available, additional attribute channels such as color, albedo, or other properties. The UI may be implemented as part of a client application or web-based tool and may provide a variety of user interface controls, visualization panes, and interactive features.

The UI may enable user interface input to be received and processed for indicating individual points or groups of points within the denoised point cloud 208. Indicated points may be visually highlighted or marked to indicate their selection status. New points may be added to the denoised point cloud 208 based on input received by the user interface (e.g., after a click in the 3D workspace or coordinate input). The GUI may cause a prompt to be presented asking for specified or adjusted attribute values such as color, albedo, or additional features for these new points. The UI may also provide controls for deleting or removing selected points, thereby updating the visual representation and underlying data.

In addition to adding or removing points, the UI may enable movement and/or repositioning existing points in the denoised point cloud 208. This movement may involve adjusting the spatial coordinates of one or more points, either individually or as a group, in order to refine or correct the geometry of the point cloud. Attribute editing may also be supported for modify point properties such as color, albedo, normal, or material properties through dedicated property panels or by using brush tools to assign attributes to selected points or regions.

The UI may further support importing and merging additional point clouds or subsets thereof. For example, points selected from a reference object can be merged into the current denoised point cloud 208 in order to append new features or correct ambiguous regions by example.

Changes reflecting modifications to the denoised point cloud 208 received from the UI may be immediately reflected in the underlying point cloud data structure. The updated denoised point cloud 208 may then be provided as input to the downstream components of point cloud system 206, including the embedding projection system 304, noisy point cloud embedding system 306, concatenation system 308, and transformer 310. This enables the entire system to regenerate or further refine the 3D representation in response to user edits.

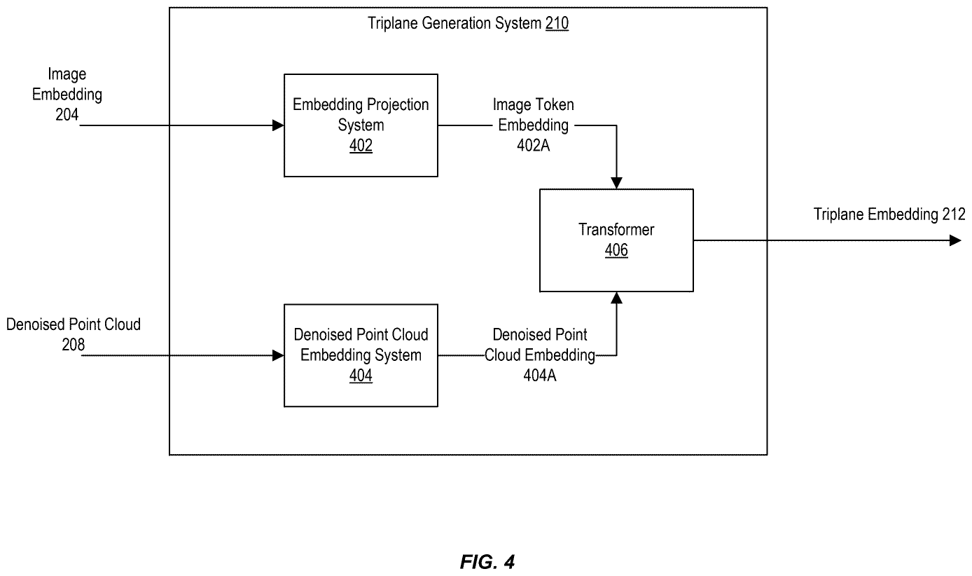

FIG. 4 is a block diagram illustrating an example triplane generation system 210 (e.g., triplane generation system 210 described above), according to certain embodiments. Triplane generation system 210 may generate triplane embedding 212 based on (e.g., based at least in part on) image embedding 204 (e.g., image embedding 204 as described above) and/or denoised point cloud 208 (e.g., denoised point cloud 208 as described above. Triplane generation system 210 may comprise an embedding projection system 402, a denoised point cloud embedding system 404, and a transformer 406.

The embedding projection system 402 can be configured to receive image embedding 204. The embedding projection system 402 may comprise an encoder, a variational auto encoder (VAE) encoder and/or a Contrastive Language-Image Pretraining model (CLIP), a Deeper Into Neural Networks (DINO) model, a DINOv2 model, etc. The embedding projection system 402 may be trained to encode the image embedding 204 into an image token embedding 402A. The image embedding 204 may comprise one or more high-dimensional token embeddings. The embedding projection system 402 can project each high-dimensional token embedding of the image embedding 204 to a common dimension to generate image token embedding 402A. The image token embedding 402A may itself comprise a sequence of multiple token embeddings, with each token embedding corresponding to a respective high-dimensional token embedding from the image embedding 204 after projection into the common dimension. This is to ensure the resulting image token embedding 402A is dimensionally compatible to be combined with other embeddings, such as the denoised point cloud embedding 404A. The embedding projection system may further include normalization and positional encoding operations to preserve spatial context and ensure feature stability.

The denoised point cloud embedding system 404 can be configured to receive denoised point cloud 208. The denoised point cloud 208 may comprise an initial set of distributed points in 3D space, each optionally associated with one or more attribute channels, as described above.

The denoised point cloud 208 may comprise a set of points in 3D space and each point may be associated with one or more attribute channels (e.g. geometry, albedo, color, etc.). The denoised point cloud embedding system 404 can project, optionally after tokenization, the per-point features of the denoised point cloud 208 to a common feature dimension, producing the denoised point cloud embedding 404A. The denoised point cloud embedding 404A may comprise a sequence of multiple token embeddings, each corresponding to a respective point in the denoised point cloud 208 after projection into the common dimension. This is to ensure that the resulting denoised point cloud embedding 404A is dimensionally compatible for combination with other embeddings, such as the image token embedding 402A. The embedding projection system may further incorporate normalization and positional encoding operations to preserve spatial context and promote stable feature representations for downstream processing.

The transformer 406 can be configured to receive the image token embedding 402A and/or the denoised point cloud embedding 404A. The transformer 406 can generate a triplane embedding 212 based on (e.g., based at least in part on) the image token embedding 402A and/or the denoised point cloud embedding 404A. In some embodiments, transformer 406 may combine by, for example, concatenating the image token embedding 402A and the denoised point cloud embedding 404A before further processing. The transformer 406 may comprise a sequence of transformer encoder layers and each encoder layer may each include multi-head self-attention, feed-forward sublayers, normalization, and residual connections.

The transformer 406 can apply attention-based operations that allow each token (whether originating from the image or point cloud, described above) to dynamically attend to and integrate contextual information from all other tokens in the input sequence. This facilitates the modeling of both local and global dependencies, allowing the transformer 406 to jointly reason about spatial, geometric, and appearance relationships within the data. By applying multi-head self-attention across the image token embedding 402A (e.g., edges, textures, color, etc.) and the attribute information from the denoised point cloud embedding 404A (e.g., surface structure, albedo, normals, etc.), the transformer 406 is able to synthesize a unified, information-rich representation. This facilitates the modeling of both local and global dependencies, such as spatial proximity, part-whole relationships, and appearance coherence across different regions of the object of image 102. As a result, the transformer 406 can leverage direct visual evidence from the image stream (e.g., edges, texture, color, etc.) while simultaneously incorporating 3D attributes encoded in the point cloud (e.g. albedo). The attention mechanism also enables the transformer 406 to synthesize a representation that more accurately reflects the underlying structure and appearance of the target object.

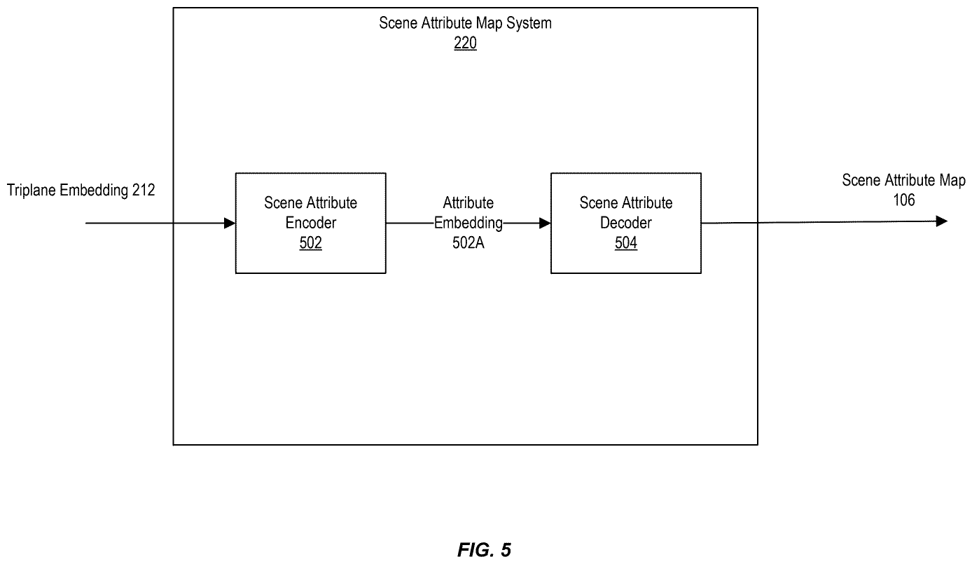

FIG. 5 is a block diagram illustrating an example scene attribute map system 220 (e.g., scene attribute map system 220 described above), according to certain embodiments. Scene attribute map system 220 may generate a scene attribute map 106 (e.g., scene attribute map 106 described above) based on (e.g., based at least in part on) the triplane embedding 212 (e.g., triplane embedding 212 described above). The scene attribute map system 220 may comprise a scene attribute encoder 502 and a scene attribute decoder 504.

The scene attribute encoder 502 may generate an attribute embedding 502A based on (e.g., based at least in part on) the triplane embedding 212. The triplane embedding 212 encodes a high-dimensional volumetric representation of the object of image 102, capturing both its geometry and appearance as inferred from the image 102 and any associated artifacts.

Upon receiving the triplane embedding 212 as input, the scene attribute encoder 502 can process this volumetric feature representation to extract salient information relevant for downstream scene attribute estimation. The scene attribute encoder 502 may comprise one or more neural network layers (e.g., fully connected (dense) layers, convolutional layers, attention-based mechanisms, etc.) configured to extract the information present in the triplane embedding 212 into a compact, information-rich vector or set of vectors, such as attribute embedding 502A.

The resulting attribute embedding 502A can encode scene attributes, such as global and/or local illumination, environmental lighting, or other contextual properties necessary for physically based rendering, relighting, or advanced material simulation. By encoding these scene attributes in a lower-dimensional space represented by the attribute embedding 502A, the scene attribute encoder 502 can enable efficient and flexible downstream operations on the environmental or contextual information.

The scene attribute decoder 504 may generate the scene attribute map 106 based on (e.g., based at least in part on) the attribute embedding 502A. The attribute embedding 502A encapsulates scene or environmental information, such as illumination, environment lighting, or other contextual properties, extracted from the triplane embedding 212.

Upon receiving the attribute embedding 502A as input, the scene attribute decoder 504 processes this compact latent representation through one or more neural network layers (e.g., fully connected (dense) layers, deconvolutional layers, specialized decoder architectures, etc.). The decoder can reconstruct or synthesize a scene attribute map 106, which may include, for example, a high-dynamic-range (HDR) environment map, an illumination distribution, or other global or local scene descriptors relevant for physically based rendering or downstream visual effects.

The scene attribute decoder 504 may be implemented as a pretrained or jointly trained neural network module, such as an attribute embedding 502A decoder (e.g., RENI++), that is capable of generating a detailed and physically plausible scene attribute map 106 from the lower-dimensional attribute embedding 502A. This enables the system to efficiently recover complex scene properties while ensuring that the generated scene attribute map 106 is consistent with the geometry, appearance, and context of the reconstructed object.

The resulting scene attribute map 106 can then be used by other downstream systems to accurately simulate lighting, relighting, or other environment-dependent effects for the 3D asset 104.

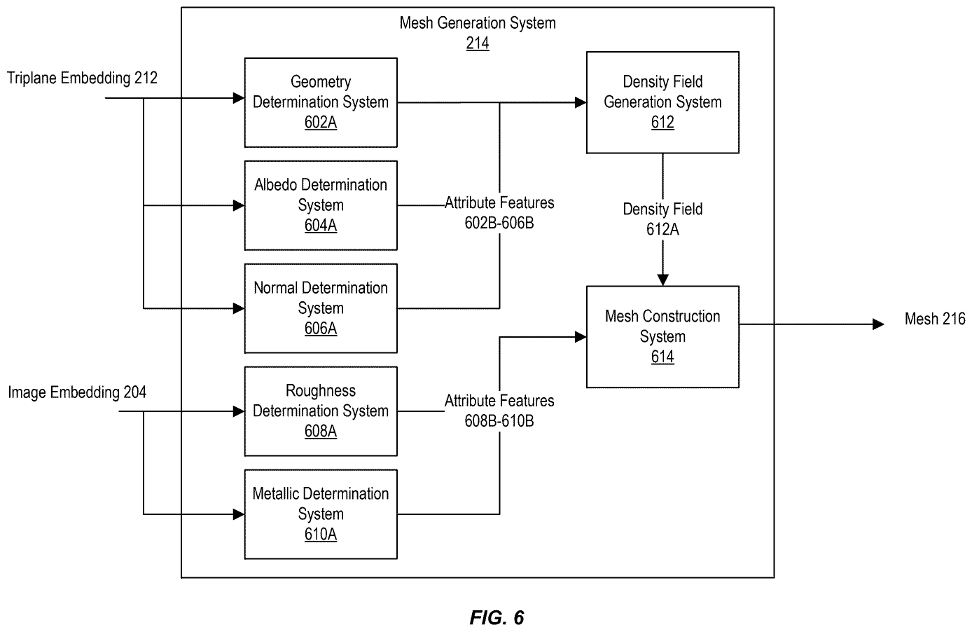

FIG. 6 is a block diagram illustrating an example mesh generation system 214 (e.g., mesh generation system 214 described above, according to certain embodiments. Mesh generation system 214 can generation mesh 216 (e.g., mesh 216 described above) based on (e.g., based at least in part on) the triplane embedding 212 (e.g., triplane embedding 212 described above) and/or image embedding 204 (e.g., image embedding 204 described above). Mesh generation system 214 may comprise a geometry determination system 602, an albedo determination system 604, a normal determination system 606, a roughness determination system 608, a metallic determination system 610, a density field generation system 612, and a mesh construction system 614.

The geometry determination system 602A, the albedo determination system 604A, and the normal determination system 606A may each, or in any combination, comprise a shallow multi-layer perceptron (MLP). In some embodiments, one or more of systems 602A-606A may alternatively comprise an encoder, a variational autoencoder (VAE) encoder, or a similar neural architecture to enable probabilistic or latent-space modeling of their respective attributes.

The geometry determination system 602A, the albedo determination system 604A, and the normal determination system 606A may each receive the triplane embedding 212 in parallel and/or process the triplane embedding 212 concurrently with one another. These systems 602A-606A can be jointly trained along with their respective attribute decoders to ensure that the feature representations learned in the triplane embedding 212 are informative not only for each system's specific attribute but also for the attributes of the other systems. Such joint training can enhance the coherence and realism of the reconstructed 3D mesh, especially in challenging regions where direct observation from the input is limited.

The geometry determination system 602A may generate an attribute value 602B based at least in part on the triplane embedding 212. The geometry determination system 602A can be configured to decode feature vectors from the triplane embedding 212 at specified three-dimensional (3D) locations, producing one or more scalar values (e.g., density) that characterize the geometry at those locations. In operation, the geometry determination system 602A may utilize a shallow multi-layer perceptron (MLP) that receives, as input, a high-dimensional feature vector formed by projecting the 3D coordinates onto each of the three orthogonal feature planes of the triplane embedding 212, interpolating the feature vectors at the corresponding two-dimensional (2D) positions, and concatenating them. The MLP can process this concatenated vector through one or more hidden layers with non-linear activations and output a scalar value representing the geometry attribute (e.g., density) at the queried point.

The albedo determination system 604A may generate an attribute value 604B based at least in part on the triplane embedding 212. The albedo determination system 604A can be configured to decode feature vectors from the triplane embedding 212 at specified 3D locations, producing one or more albedo values (e.g., RGB color vectors) that represent the intrinsic surface color at those locations. The albedo determination system 604A may utilize a shallow multi-layer perceptron (MLP) that receives, as input, a high-dimensional feature vector formed by projecting the 3D coordinates onto each of the three orthogonal feature planes of the triplane embedding 212, interpolating the feature vectors at the corresponding 2D positions, and concatenating them. The MLP can process this concatenated vector through one or more hidden layers with non-linear activations and output an albedo value (e.g., RGB) specifying the intrinsic color at the queried point on the object's surface.

The normal determination system 606A may generate an attribute value 606B based at least in part on the triplane embedding 212. The normal determination system 606A can be configured to decode feature vectors from the triplane embedding 212 at specified 3D locations, outputting one or more values that represent the surface normal or orientation at those locations. The normal determination system 606A may employ a shallow multi-layer perceptron (MLP) that receives, as input, a high-dimensional feature vector formed by projecting the 3D coordinates onto each of the three orthogonal feature planes of the triplane embedding 212, interpolating the feature vectors at the corresponding 2D positions, and concatenating them. The MLP can process this concatenated vector through one or more hidden layers with non-linear activations and output a surface normal (e.g., a 3D vector) representing the orientation at the queried point on the object's surface.

The geometry determination system 602A, the albedo determination system 604A, and the normal determination system 606A may each, or in any combination, comprise a shallow multi-layer perceptron (MLP). In some embodiments, one or more of systems 602A-606A may alternatively comprise an encoder, a variational autoencoder (VAE) encoder, or a similar neural architecture to enable probabilistic or latent-space modeling of their respective attributes.

The roughness determination system 608A and the metallic determination system 610A may each receive the image embedding 204 in parallel and/or process the image embedding 204 concurrently with one another. These systems 608A-610A can be jointly trained along with their respective attribute decoders to ensure that the feature representations learned in the image embedding 204 are informative not only for each system's specific attribute but also for the attributes of the other system. Such joint training can enhance the coherence and realism of the reconstructed 3D mesh, especially in challenging regions where direct observation from the input is limited.

The roughness determination system 608A and the metallic determination system 610A may each, or in any combination, comprise a shallow multi-layer perceptron (MLP). In some embodiments, one or more of systems 608A-610A may alternatively comprise an encoder, a variational autoencoder (VAE) encoder, or a similar neural architecture to enable probabilistic or latent-space modeling of their respective attributes.

The roughness determination system 608A may generate an attribute feature 608B based on (e.g., based at least in part on) the image embedding 204. The roughness determination system 608A can be configured to decode global or local roughness information that characterizes the facet distribution of the object's surface, thereby influencing the glossiness or matte appearance in rendered images/objects. The roughness determination system 608A can comprise a shallow neural network, such as a multi-layer perceptron (MLP), that receives the image embedding 204 (or a feature vector derived therefrom) as input. The MLP can process this input through one or more hidden layers with non-linear activations and output a roughness value or map. The roughness determination system 608A may learn to estimate roughness using a probabilistic approach utilizing an interval-bounded probability prior (e.g., Beta prior), which enables robust modeling of uncertainty and variability in material properties. The roughness determination system 608A may utilize an encoder (e.g., AlphaCLIP), which leverages foreground object masks to improve robustness and consistency in roughness estimation. The predicted roughness value or map may be assigned as a per-object, per-region, or per-vertex/material parameter for the mesh 216.

The metallic determination system 610A may generate an attribute feature 610B based on (e.g., based at least in part on) the image embedding 204. The metallic determination system 610A can be configured to decode global or local metallicity information that characterizes the extent to which regions of the object's surface exhibit metallic properties, thereby influencing the reflectivity and overall appearance of rendered images/objects. The metallic determination system 610A can comprise a shallow neural network, such as a multi-layer perceptron (MLP), that receives the image embedding 204 (or a feature vector derived therefrom) as input. The MLP can process this input through one or more hidden layers with non-linear activations and output a metallic value or map. The metallic determination system 610A may learn to estimate metallicity using a probabilistic approach utilizing an interval-bounded probability prior (e.g., Beta prior), which enables robust modeling of uncertainty and variability in material properties. The metallic determination system 610A may utilize an encoder (e.g., AlphaCLIP), which leverages foreground object masks to improve robustness and consistency in metallicity estimation. The predicted metallic value or map may be assigned as a per-object, per-region, or per-vertex/material parameter for the mesh 216.

The density field generation system 612 may generate a density field 612A based on (e.g., based at least in part on) one or more of the received attribute features 602B-606B. The density field 612A can be a scalar field defined over a region of three-dimensional space, where each value indicates the likelihood or degree to which a given location is occupied by the object's surface. The density field generation system 612 can receive, as input, the geometry attribute values 602B (e.g., density or occupancy values) computed at a dense grid or set of sampled 3D locations. In some embodiments, the system 612 may also incorporate additional attribute features, such as albedo (e.g., attribute value 604B) and normals (e.g., attribute value 606B), to provide contextual or auxiliary information that improves the accuracy and coherence of the density field, particularly in regions with ambiguous or incomplete geometric evidence.

The density field generation system 612 may process the attribute values 602B-606B to produce a continuous or discretized density field 612A. The density field 612A can define, for each location within the region of interest, a scalar density value that is used to define the boundary between the object's interior and exterior.

The mesh construction system 614 may generate the mesh 216 based on (e.g., based at least in part on) the density field 612A and, optionally, one or more of the attribute features 608B-610B. The mesh construction system may use isosurface extraction algorithms such as marching tetrahedra or marching cubes, which can systematically traverse the density field 612A to identify the set of points where the density crosses a predetermined threshold (e.g., “isosurface”). These algorithms can partition the 3D space into simple geometric elements (e.g., tetrahedra, cubes, etc.), evaluate the density at each vertex, and connect the surface points to form a continuous polygonal mesh that accurately represents the object's exterior boundary.

The mesh construction system 614 may further augment the mesh 216 with per-vertex or per-face attributes derived from the attribute features 608B-610B. For example, the mesh construction system 614 can assign metallic, roughness, or other material properties to each mesh element by querying the corresponding attribute decoders at the locations of the mesh's vertices, or by interpolating attribute values from the predicted attribute fields across the mesh surface. This process can enrich the mesh 216 with detailed material properties, enabling physically based rendering (PBR), realistic visualization, and compatibility with downstream processing in graphics engines and asset pipelines.

In certain embodiments, properties such as albedo, metallic, roughness, and tangent normals are not encoded directly on the mesh 216, but are instead stored in texture maps, which can be two-dimensional images or data arrays that encode material properties for the mesh surface. In such embodiments, each mesh vertex of the mesh 216 can be associated with UV coordinates (i.e., two-dimensional coordinates specifying locations in the texture map) that reference positions within a texture map, which can allow material properties to be efficiently mapped onto the surface of the mesh 216. Such embodiments can result in higher visual quality compared to direct per-vertex encoding, since texture maps can represent fine details without requiring extremely high mesh resolutions.

In some embodiments, the mesh construction system 614 may also use one or more training losses: a normal consistency loss, a Laplacian smoothness loss, and a vertex offset regularization. For supervising the normal prediction, certain embodiments use a geometry normal replication loss=1−n·\hat{ }n, where · is the dot product and a normal smoothness loss to ensure the smoothness of normal predictions in 3D. The geometry normal replication loss can be achieved by adding a small offset ϵ around a query location x. The loss is then defined as =(\hat{ }n(x)−\hat{ }n(x+ϵ))\hat{ }2.

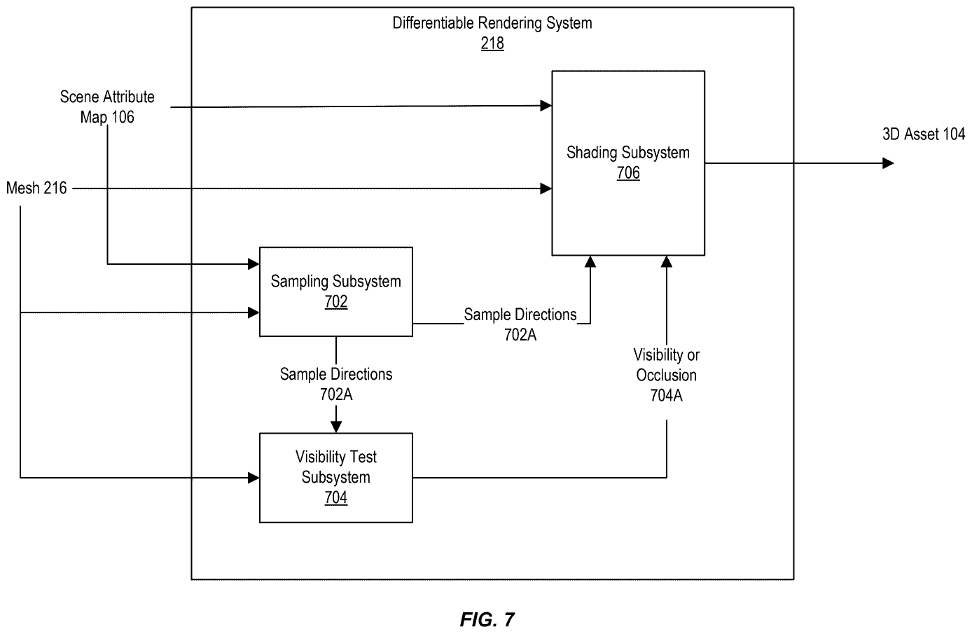

FIG. 7 is a block diagram illustrating an example differentiable rendering system 218 (e.g., differentiable rendering system 218 described above), according to certain embodiments. The differentiable rendering system 218 may generate and/or render the 3D asset 104 (e.g., 3D asset 104 described above) based on (e.g., based at least in part on) the mesh 216 (e.g., mesh 216 described above), and/or the scene attribute map 106 (e.g., scene attribute map 106 described above). The differentiable rendering system 218 may comprise a shading subsystem 706, a sampling subsystem 702, and/or a visibility test subsystem 704.

The sampling subsystem 702 may generate sampled directions 702A based on (e.g., based at least in part on) the scene attribute map 106 (e.g., scene attribute map 106 described above) and/or the mesh 216 (e.g., mesh 216 described above). The sampling subsystem 702 may receive as input the scene attribute map 106 generated by the scene attribute map system 220 (e.g., scene attribute map system 220 described above), as well the mesh 216 generated by the mesh generation system 214 (e.g., mesh generation system 214 described above). Using these inputs, the sampling subsystem 702 can derive relevant lighting and environmental information, such as the locations, intensities, and distributions of light sources, environment maps, and any other contextual illumination attributes contained in the scene attribute map 106.

Based on the geometry and/or properties defined by the mesh 216, the illumination conditions provided by the scene attribute map 106, and/or other attribute data, the sampling subsystem 702 may determine an appropriate set of sampled directions 702A for each surface point or region of the mesh 216. The selection of sampled directions 702A can be accomplished using techniques such as Monte Carlo sampling, Multiple Importance Sampling (MIS), uniform or stratified sampling over the hemisphere, or other sampling strategies informed by the surface reflectance characteristics (e.g., BRDF), material parameters (e.g., albedo, metallic, roughness), and the distribution of scene illumination. For each surface point, the sampling subsystem 702 may output a set of sampled directions 702A, where each direction is associated with its corresponding surface location and an importance weight or probability density. These weights may be determined according to the chosen sampling strategy and can be used enable unbiased and efficient estimation of outgoing radiance during rendering. In some embodiments, the sampling subsystem 702 may select sampling strategies or adjust the number of samples based on the estimated material complexity, lighting variation, rendering budget, and/or other factors, to improve the efficiency and accuracy of the rendering process.

The visibility test subsystem 704 may generate the visibility or occlusion 704A based on (e.g., based at least in part on) the sampled directions 702A. The visibility test subsystem 704 may receive as input the set of sampled directions 702A produced by the sampling subsystem 702, along with the mesh 216 and/or any relevant contextual information. For each sampled direction, the visibility test subsystem 704 may determine whether the direction is occluded or visible by performing geometric intersection tests (e.g, ray casting), ray-marching, or screen-space depth comparisons using the mesh 216. The visibility or occlusion 704A can indicate, for each sampled direction 702A, whether it is blocked or unobstructed. The visibility or occlusion 704A generated by the visibility test subsystem 704 may then be transmitted to the shading subsystem 706 for further processing, such as subsequent lighting, shading, etc., computations. In certain embodiments, the visibility test subsystem 704 may also compute partial visibility or soft shadowing by aggregating results from multiple sampled directions or by employing probabilistic or differentiable shadowing techniques.

The shading subsystem 706 may generate and/or render the 3D asset 104 based on (e.g., based at least in part on) the scene attribute map 106 (e.g., scene attribute map 106 described above), the mesh 216 (e.g., mesh 216 described above), sample directions 702A, and/or the visibility or occlusion 706A. In certain embodiments, shading subsystem 706 may generate a rendering of the 3D asset 104. The shading subsystem 706 may implement a physically based reflectance model, such as the Disney Bidirectional Reflectance Distribution Function (BRDF), to process each relevant surface point of the mesh 216. The shading subsystem 706 may receive, as input, material parameters such as albedo, metallic, and roughness attributes; the surface normal at the shading point; the incoming light direction; visibility information; and the outgoing view direction. Using these inputs, the shading subsystem 706 may compute the outgoing radiance and/or color for each surface point corresponding to the sampled directions 702A and thereby render the 3D asset 104, which can be a 3D representation of image 102 (e.g., image 102 described above). The 3D asset 104 can depict how the image 102 or the object associated with image 102 would appear under the specified lighting and viewing conditions.

### II. Method

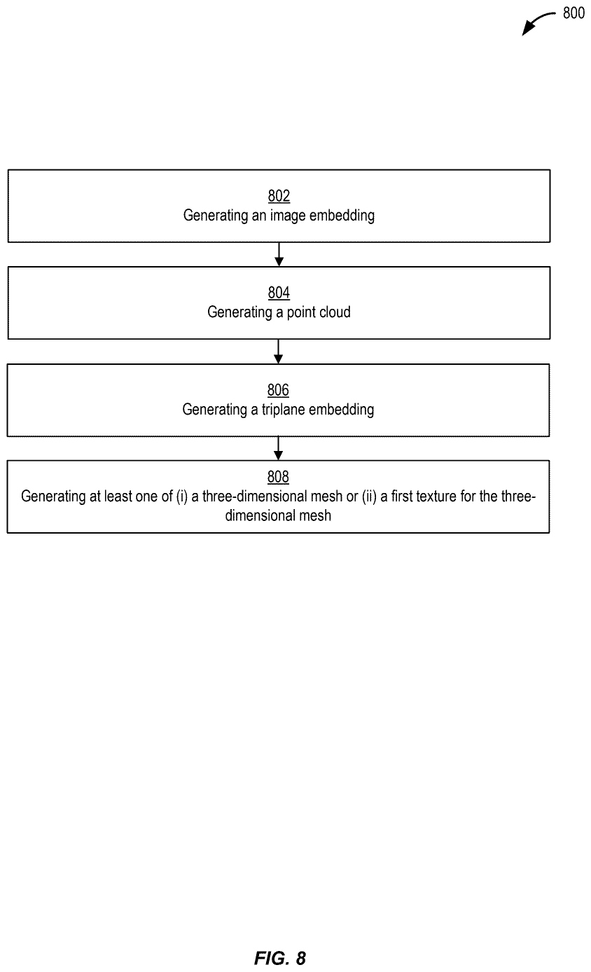

The processing performed using the inference system architecture described above with respect to FIGS. 1-7 may be implemented using an inference time method. Examples of such methods are described below with respect to method 800 as depicted in FIG. 8.

The processing depicted in method 800 and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in method 800, and other FIGS. and described herein are intended to be illustrative and non-limiting. Although method 800, and other FIGS., depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in method 800, and other FIGS., may include a greater number or a lesser number of steps than those depicted in the respective FIGS.

FIG. 8 is a block diagram illustrating an example method 800 of using an asset generation system, according to certain embodiments of the present disclosure. The method may be performed by the asset generation system 100 described above.

At S802 an image embedding (e.g., image embedding 204 described above) may be received. The image embedding may generated based on (e.g., based at least in part on) an object. The object may be an image of an object (e.g., image 102 as described above).

At S804 a point cloud (e.g., denoised point cloud 208 described above) may be generated. The point cloud may be generated based on (e.g., based at least in part on) the image embedding.

The point cloud may comprise a plurality of points conditioned on the image embedding. A point included in the point cloud may comprise at least one of (i) a three-dimensional spatial coordinate, (ii) a color value, (iii) a metallic value, or (iv) an orientation value. The point comprising a three-dimensional spatial coordinate may include an X value, a Y value, and a Z value. The point comprising a color value may include a red (R) channel, a green (G) channel, and a blue (B) channel. The point cloud may be generated by using the asset generation system and/or components included in the asset generation system as described above. The attributes of the point may be determined using the techniques described herein and by a point cloud system (e.g., point cloud system 206).

A point cloud may be associated with at least one albedo value. Each of the at least one albedo value may be associated with at least one point in the point cloud. In some embodiments the method 800 may further comprise instructions that comprise utilizing the at least one albedo value in the point cloud as conditioning input for estimating an intrinsic surface color of the object, such that the first three-dimensional mesh includes attributes based on (e.g., based at least in part) on the at least one albedo value of the point cloud. The at least one albedo value may be determined in accordance with the techniques described herein and by an albedo determination system (e.g., albedo determination system 604A described above).

At S806 a triplane embedding (e.g., triplane embedding 212 described above) may be generated. The triplane embedding may be generated to represent the object based on (e.g., based at least in part on) the image embedding and the point cloud.

At S808 at least one of (i) a first three-dimensional mesh (e.g., mesh 216 described above) or (ii) a first texture for the three-dimensional mesh (e.g., 3D asset 104 described above) may be generated. The three-dimensional mesh and/or the first texture for the three-dimensional mesh may be generated based on (e.g., based at least in part on) the triplane embedding.

In some embodiments, method 800 may further comprise generating a rendering (e.g., 3D asset 104) based on (e.g., based at least in part on) the first three-dimensional mesh associated with the object. The rendering may comprise projecting a ray onto a surface point of the first three-dimensional mesh to compare a depth of the ray with a depth map associated with the first three-dimensional mesh. Based on (e.g., based at least in part on) the comparison, the ray can be determined to be occluded by a portion of the first three-dimensional mesh. This indicates the portion is closer to the ray than the surface point along a direction of the ray. The rendering may be modified by modifying an illumination of the surface point based on (e.g., based at least in part on) the determination that the ray is occluded. Techniques described herein can accomplish aspect of the described and by the differentiable rendering system (e.g., differentiable rendering system described above)

The three-dimensional mesh may be used to present the object from a first view. In some embodiments, the three-dimensional mesh may be used to generate a three-dimensional image depicting an object associated with the image (e.g., 3D asset 104); the three-dimensional image can present the object from a first view. In some embodiments, method 800 may further comprise instructions that causes the first three-dimensional mesh to be presented from a second view that is different from the first view. For example, an object may be presented from a front view and/or the image may depict an object from a front view, which informs the generation of the first three-dimensional mesh. Modifications to the first three-dimensional mesh may then cause the rendering of the first three-dimensional mesh to present the object from a rear view.

In some embodiments, method 800 may further comprise generating a first scene attribute map (e.g., scene attribute map 106 described above). The first scene attribute map may be associated with illumination data. As described herein, the illumination data may be derived from the triplane embedding using a scene attribute map system (e.g., scene attribute map system 220 described above).

In some embodiments, the method 800 may further comprise instructions for receiving a second scene attribute map. The second scene attribute map can be distinct from the first scene attribute map. The first three-dimensional mesh may be based on (e.g., based at least in part on) the second scene attribute map. For example, a first scene attribute map may encode for daytime lighting conditions whereas a second scene attribute map may encode for nighttime lighting conditions. The object can be rendered for daytime or nighttime lighting conditions given whichever scene attribute map is used in conjunction with three-dimensional mesh.

In some embodiments, method 800 may further comprise receiving one or more signals from a user interface that indicates a modification to the point cloud. The point cloud may be modified based on the one or more signals to generate a modified point cloud. For example, as described above, one or more points on the point cloud may be modified for color, location, etc. At least one of (i) a second three-dimensional mesh different from the first three-dimensional mesh or (ii) a second texture different from the first texture may be generated. The second three-dimensional mesh may be associated with the object. In other words, an object may have one or more three-dimensional meshes and/or one or more textures generated in associated with the object.

In some embodiments, method 800 may further comprise generating an image token embedding (e.g., image token embedding 304A described above) based on (e.g., based at least in part on) inputting the image embedding (e.g., image embedding 204 described above) to a embedding projection system (e.g., embedding projection system 304 described above). A noisy point cloud embedding (e.g., noise point cloud embedding 306A described above) may be generated based on (e.g., based at least in part on) inputting a noisy point cloud (e.g., noisy point cloud 302) to a point cloud embedding system (e.g., noisy point cloud embedding system 306 described above). A combined embedding (e.g., concatenated embedding 308A) may be generated based on (e.g., based at least in part on) combining the image token embedding and the noisy point cloud embedding. A point cloud (e.g., denoise point cloud 208, described above) associated with the object (e.g., image 102) may be generated based on (e.g., based at least in part on) inputting the combined embedding to a transformer model (e.g., transformer 310 described above).

The image token embedding and the noisy point cloud embedding may be dimensionally aligned by projecting the image embedding and the noisy point cloud embedding to a common dimension.

In some embodiments, method 800 may generate an image token embedding (e.g., image token embedding 304A described above) based on (e.g., based at least in part on) inputting the image embedding into an embedding projection system (e.g., embedding projection system 402 described above). A denoised point cloud embedding (e.g., denoised point cloud embedding 404A described above) may be generated by inputting a denoised point cloud (e.g., denoised point cloud 208 described above) to a denoised point cloud embedding system (e.g., denoised point cloud embedding system 404 described above). A triplane embedding (e.g., triplane embedding 212 described above) may be generated based on (e.g., based at least in part on) inputting the image token embedding and the denoised point cloud embedding to a transformer model (e.g., transformer 406 described above).

The image token embedding and the denoised point cloud embedding may be dimensionally aligned by projecting the image embedding and the denoised point cloud embedding to a common dimension.

In some embodiments, method 800 may generate an attribute embedding (e.g., attribute embedding 502A described above) based on (e.g., based at least in part on) inputting the triplane embedding (e.g., triplane embedding 212 described above) to a scene attribute encoder (e.g., scene attribute encoder 502). The attribute embedding may comprise at least one albedo value. The first scene attribute map (e.g., scene attribute map 106 described above) may be generated based on (e.g., based at least in part on) inputting the attribute embedding to a scene attribute decoder (e.g., scene attribute decoder 504 described above).

In some embodiments, method 800 further comprises generating one or attribute features (e.g., attribute features 602B-610B described above) based on (e.g., based at least in part on) inputting the triplane embedding (e.g. triplane embedding 212 described above) and/or the image embedding (e.g., image embedding 204 described above) into a respective attribute determination system (e.g., systems 602A-610A described above). The one or more attribute features can encode an attribute associated with the object (e.g., image 102 described above). A density field (e.g., density field 612A described above) can be generated based on (e.g., based at least in part on) inputting the one or more attribute features to a density field generation system (e.g., density field generation system 612 described above). The first three-dimension mesh (e.g., mesh 216 described above) can be generated based on (e.g., based at least in part on) inputting the density field or the one or more attribute features to a mesh construction system (e.g., mesh construction system 614 described above).

### III. Computer System

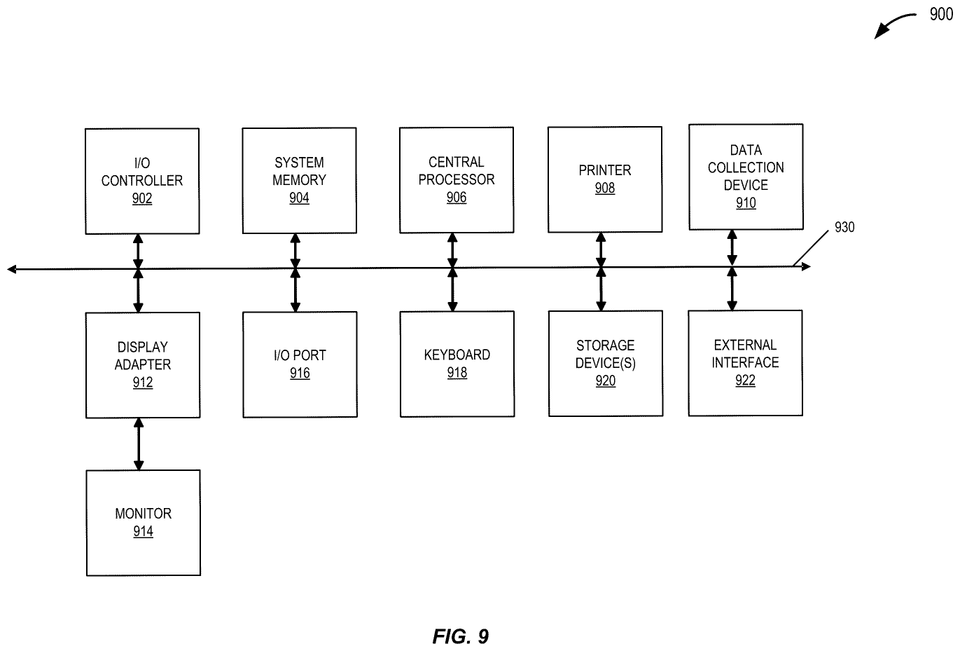

Any of the computer systems mentioned herein may utilize any suitable number of subsystems. Examples of such subsystems are shown in FIG. 9 in computer system 900. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 9 are interconnected via a system bus 930. Additional subsystems such as a printer 908, keyboard 918, storage device(s) 920, monitor 914 (e.g., a display screen, such as an LED), which is coupled to display adapter 912, and others are shown. Peripherals and input/output (I/O) devices, which couple to I/O controller 902, can be connected to the computer system by any number of means known in the art such as input/output (I/O) port 916 (e.g., USB, FireWire®). For example, I/O port 916 or external interface 922 (e.g., Ethernet, Wi-Fi, etc.) can be used to connect computer system 900 to a wide area network such as the Internet, a mouse input device, or a scanner. The interconnection via system bus 930 allows the central processor 906 to communicate with each subsystem and to control the execution of a plurality of instructions from system memory 904 or the storage device(s) 920 (e.g., a fixed disk, such as a hard drive, or optical disk), as well as the exchange of information between subsystems. The system memory 904 and/or the storage device(s) 920 may embody a computer readable medium. Another subsystem is a data collection device 910, such as a camera, microphone, accelerometer, and the like. Any of the data mentioned herein can be output from one component to another component and can be output to the user.

A computer system can include a plurality of the same components or subsystems, e.g., connected together by external interface 922, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. The computations can be performed in parallel by the different processing units and/or different processing threads of a single processing unit. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such devices. In addition, the order of operations may be re-arranged. A process can be terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium according to an embodiment of the disclosed techniques may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The above description is illustrative and is not restrictive. Many variations of the disclosed will become apparent to those skilled in the art upon review of the disclosure. The scope of the disclosed should, therefore, be determined not with reference to the above description, but instead should be determined with reference to the pending claims along with their full scope or equivalents.

One or more features from any embodiment may be combined with one or more features of any other embodiment without departing from the scope of the disclosed.

A recitation of “a,” “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted as prior art. Where a conflict exists between the instant application and a reference provided herein, the instant application shall dominate.

What is claimed is:

1. A system comprising:
one or more storage media storing instructions; and
one or more processors configured to execute the instructions to cause the system to:
generate an image embedding based at least in part on an object;
generate a point cloud associated with the object based at least in part on the image embedding;
generate a triplane embedding representing the object based at least in part on the image embedding and the point cloud; and
generate, based at least in part on the triplane embedding, at least one of (i) a first three-dimensional mesh associated with the object or (ii) a first texture for the first three-dimensional mesh associated with the object.

2. The system of claim 1, wherein the execution of the instructions further causes the system to:
generate a first scene attribute map based on the triplane embedding, wherein the first scene attribute map encodes illumination data.

3. The system of claim 2, wherein the execution of the instructions further causes the system to:
receive a second scene attribute map, wherein the second scene attribute map is distinct from the first scene attribute map; and
render the first three-dimensional mesh based at least in part on the second scene attribute map.

4. The system of claim 1, wherein the object is presented from a first view; and
wherein the execution of the instructions further causes the system to present the first three-dimensional mesh from a second view that is different from the first view.

5. The system of claim 1, wherein the point cloud includes at least one albedo value, and wherein generating the first three-dimensional mesh comprises:
utilizing the at least one albedo value included in the point cloud as conditioning input for estimating an intrinsic surface color of the object, such that the first three-dimensional mesh includes attributes based at least in part on the at least one albedo value of the point cloud.

6. The system of claim 1, wherein generating a rendering based at least in part on the first three-dimensional mesh associated with the object comprises execution of the instructions to further cause the system to:
project a ray onto a surface point of the first three-dimensional mesh;
compare a depth of the ray with a depth map associated with the first three-dimensional mesh;
determine, based at least in part on the comparison, the ray is occluded by a portion of the first three-dimensional mesh, wherein the portion is closer to the ray than the surface point along a direction of the ray; and
modify the rendering, the modification comprising modifying an illumination of the surface point based at least in part on the determination the ray is occluded.

7. The system of claim 1, wherein the execution of the instructions further causes the system to:
generate an image token embedding based at least in part on inputting the image embedding to an embedding projection system;
generate a denoised point cloud embedding based at least in part on inputting a denoised point cloud to a denoised point cloud embedding system; and
generate the triplane embedding representing the object based at least in part on inputting the image token embedding and denoised point cloud embedding to a transformer model.

8. The system of claim 7, wherein the image token embedding and the denoised point cloud embedding are dimensionally aligned by projecting the image embedding and the denoised point cloud embedding to a common dimension.

9. The system of claim 2, wherein the execution of the instructions further causes the system to:
generate an attribute embedding based at least in part on inputting the triplane embedding to a scene attribute encoder, wherein the attribute embedding comprises at least one albedo value; and
generate the first scene attribute map based at least in part on inputting the attribute embedding to a scene attribute decoder.

10. The system of claim 1, wherein the execution of the instructions further causes the system to:
generate one or more attribute features based at least in part on inputting the triplane embedding or the image embedding into a respective attribute determination system, wherein the one or more attribute features encode an attribute associated with the object;
generate a density field based at least in part on inputting the one or more attribute features to a density field generation system; and
generate the first three-dimensional mesh based at least in part on inputting at least one of the density field or the one or more attribute features to a mesh construction system.

11. A method comprising:
generating an image embedding based at least in part on an object;
generating a point cloud associated with the object based at least in part on the image embedding;
generating a triplane embedding representing the object based at least in part on the image embedding and the point cloud; and
generating, based at least in part on the triplane embedding, at least one of (i) a first three-dimensional mesh associated with the object or (ii) a first texture for the first three-dimensional mesh associated with the object.

12. The method of claim 11 further comprising:
generating a first scene attribute map based on the triplane embedding, wherein the first scene attribute map is associated with illumination data.

13. The method of claim 11, wherein the point cloud comprises a plurality of points conditioned on the image embedding, wherein a point included in the point cloud comprises at least one of (i) a three-dimensional spatial coordinate, (ii) a color value, (iii) a metallic value, or (iv) an orientation value.

14. The method of claim 13, wherein the color value includes a red (R) channel, a green (G) channel, and a blue (B) channel.

15. The method of claim 11, further comprising:
receiving one or more signals from a user interface that indicate a modification to the point cloud;
modifying the point cloud based on the one or more signals to generate a modified point cloud; and
generating at least one of: (i) a second three-dimensional mesh associated with the object, (ii) or a second texture based at least in part on the modified point cloud, wherein the second three-dimensional mesh is different from the first three-dimensional mesh and the second texture is different than the first texture.

16. The method of claim 11 further comprising:
generating a rendering based at least in part on the first three-dimensional mesh associated with the object.

17. One or more non-transitory computer-readable storage media storing instructions that, upon execution by one or more processors of a system, cause the system to perform operations comprising:
generating an image embedding based at least in part on an object;
generating a point cloud associated with the object based at least in part on the image embedding;
generating a triplane embedding representing the object based at least in part on the image embedding and the point cloud; and
generating, based at least in part on the triplane embedding, at least one of (i) a first three-dimensional mesh associated with the object or (ii) a first texture for the first three-dimensional mesh associated with the object.

18. The one or more non-transitory computer-readable storage media of claim 17, wherein the operations further comprise:
generating a first scene attribute map based on the triplane embedding, wherein the first scene attribute map is associated with illumination data.

19. The one or more non-transitory computer-readable storage media of claim 17, wherein the operations further comprise:
generating an image token embedding based at least in part on inputting the image embedding to an embedding projection system;
generating a noisy point cloud embedding based at least in part on inputting a noisy point cloud to a point cloud embedding system;
generating a combined embedding based at least in part on combining the image token embedding and the noisy point cloud embedding; and
generating the point cloud associated with the object based at least in part on inputting the combined embedding to a transformer model.

20. The one or more non-transitory computer-readable storage media of claim 19, wherein the image token embedding and the noisy point cloud embedding are dimensionally aligned by projecting the image embedding and the noisy point cloud embedding to a common dimension.
